(19) United States
(12) Patent Application Publication
(10) Pub. No.: US 2016/0304329 A1
(43) Pub. Date: Oct. 20, 2016

(54) LIFTING DEVICE

(71) Applicant: VELVISION OY, Tampere (FI)

(72) Inventor: Veli-Matti Jussila, Lempaala (FI)

(21) Appl. No.: 14/783,460

(22) PCT Filed: Apr. 10, 2014
(86) PCT No.: PCT/FI2014/050259

§ 371 Date: Oct. 9, 2015

(30) Foreign Application Priority Data
Apr. 12, 2013 (FI) U20134094

(51) Int. Cl. B66F 11/04; B66F 7/08; B66F 7/06

(52) U.S. Cl. CPC B66F 11/04; B66F 7/0625; B66F 7/0608; B66F 7/065; B66F 7/08

(57) ABSTRACT

A lifting device construction (1), comprising a walking platform (6), a working platform (7) connected thereto with vertical members, and a hoist mechanism (8) for maneuvering an assembly made up by the working platform (7) and the walking platform (6) together, so that when the lifting device construction (1) is in its bottom position, the hoist mechanism (8), regarding its main components, is accommodated between the working platform (7) and the walking platform (6).

The invention relates to a lifting device construction. More specifically, the invention relates to a movable personnel lift.

Various construction/renovation projects require the use of personnel lifts for hoisting employees to a proper working height, for example in the process of renovating or constructing a building wall.

One such personnel lift of the prior art is a scissor lift, employing a contractible and extensible scissor mechanism for operating a lift platform on which stands a person to be moved around. The personnel lift is typically operable in a self-propelled fashion upon wheels installed thereunder. The personnel lift has its control instruments typically included in a control panel mounted on a guardrail of the lift platform. Hence, the panel enables a lifting device to be moved around by driving the lifting device and the lift platform to be hoisted to a desired height. Typically, such a scissor lift is operated by means of a hydraulic cylinder/cylinders. In its lowest position, the device has its lift platform lying typically, at a height of just over a meter and, depending. on the design, can be hoisted from there to the height of about 4-6 meters.

Another prior known solution for a personnel lift is the employment of a lifting bucket at the end of a lifting boom. Such a solution can be mounted on a trailer for moving it to the worksite by being towed with a car. Like in the above-described solution, the lifting bucket is controlled from a control panel mounted on a lifting bucket guardrail. The lifting boom operation can be based solely on the control of fixed boom structures or else the boom structure may include hydraulically operating telescopic mechanisms capable of providing the lifting device with a more extensive working range.

Typically, in all prior art solutions, the personnel lifts can also be used to some extent for hoisting various working supplies/building materials to a worksite and back again. The necessary working supplies, such as for example wall or ceiling paneling accessories and the like, are loaded on the floor of a personnel lift and hoisted to the destination at a working height. The worker installs the carried amount of material and returns on the personnel lift to a lower level for a pickup of the next installation batch. Thus, the employed working supplies/building materials are prepared, for example to a correct dimension or size, on ground/floor level. For speedier work, it is preferable that one worker be used in the preparation of a new installation batch and another on the personnel lift in the installation of a previous batch

The solution according to the invention provides an improvement for prior art solutions by making it possible to work at a worksite with a minimal number of disruptions and by minimizing the number of required employees.

This is possible with a solution of the invention, wherein the lifting device construction comprises separately a walking platform and a working platform, as well as a hoist mechanism for the lifting device construction which is accommodated substantially between the walking platform and the working platform when the lifting device construction is in its bottom position. An integral assembly made up by the walking platform and the working platform is lifted by the hoist mechanism from below the working platform, whereby, when the lifting device construction is in a closed position, the hoist mechanism, regarding its main components, is capable of fitting in a space between the working platform and the walking platform.

The walking platform may extend at least partially or completely around the working platform. When it is desirable to maximize the working platform size, it is possible to limit the walking platform size to no more than a small working spot at some point along an edge of the working platform. On the other hand, whenever necessary, and depending on a work project, the walking platform can be expanded to comprise various extensions along which the installation and maintenance work can be performed over a more extensive range with a single position setting of the lifting device construction. It is preferred that such walking platform expansion elements not be attached to the lifting device construction until at the worksite.

Likewise, the working platform can be enlarged with expansion elements for providing a working platform of required size. In certain jobs, it is preferred that the working platform be located on one side of the lifting device construction, whereby for example the mass of building supplies present on the working platform and the mass of persons standing on the walking platform balance each other. Most preferably, this working platform expansibility is implementable by means of collapsible working platform modules, whereby, when the working platform is in a non-expanded configuration, it is possible to move around the working platform from anywhere, but once expanded, the walking platform lies right next to a current work project and the working platform lies further out from the project. In a respective manner, the walking platform enlargement is also carried out by means of collapsible walking platform modules.

According to a particularly preferred embodiment of the lifting device construction, the hoist mechanism comprises at least two threaded telescopic mechanisms. This solution enables a variable length lifting device construction, whereby, the lifting device construction frame in a transport condition can be set in a short configuration, but converted at the worksite, as necessary, to a long configuration for increasing a working extent e.g. along the length of a wall at the worksite, thereby in turn improving work efficiency with less parking of the lifting device construction on a new spot.

The above-described design in a lifting device construction enables easy ascent to a top of the lifting device construction, setting up a working platform (for example, in order to finish materials for installation), attachment of various accessories to the working platform, and overall speeding up the work and minimizing the personnel (work efficiency maximization). By using expansion elements for the walking platform, the working range can be expanded, thereby reducing the necessity of moving the lifting device construction.

The lifting device construction can be integrated with a trailer for easy transport from worksite to worksite, or else the lifting device construction can have its own chassis with wheels. In this case, the lifting device construction is readily movable for example by means of an electric motor.

The invention will now be described more precisely with reference to the drawings, in which

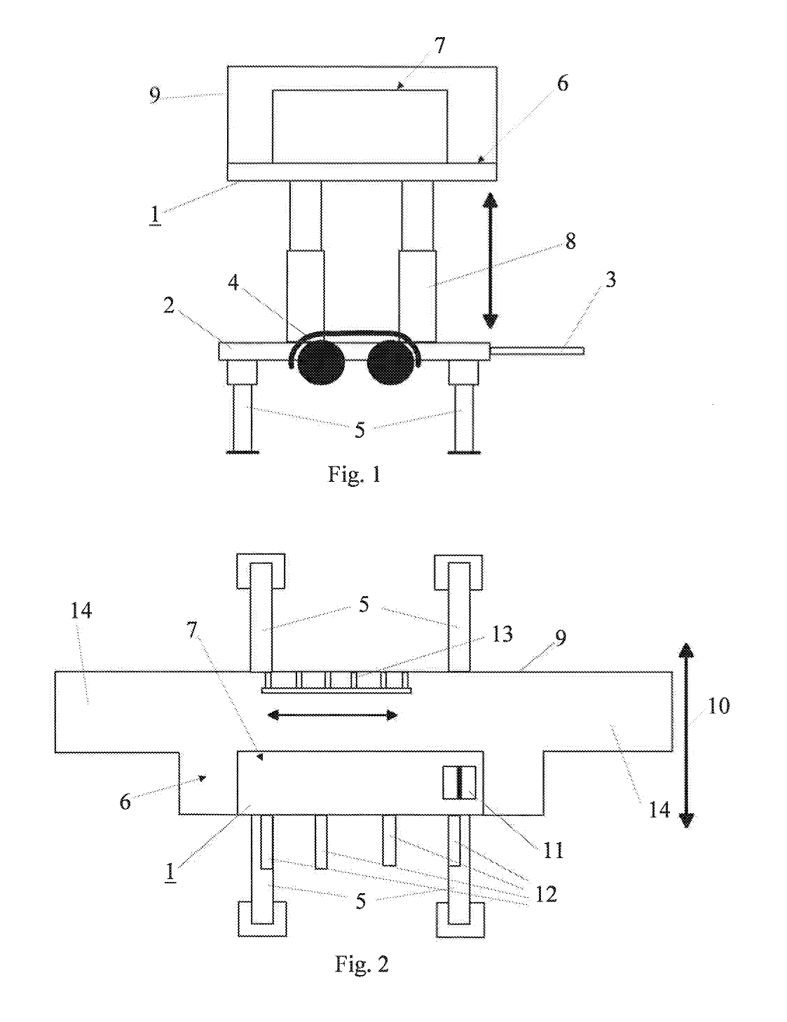

FIG. 1 shows, in a simplified schematic drawing, one preferred embodiment for a lifting device construction of the invention in a side view, and

FIG. 2 shows, in a simplified schematic drawing, one second preferred embodiment for a lifting device construction of the invention in an overhead view.

FIG. 1 shows one embodiment for a lifting device construction 1 of the invention. In this particular embodiment, the lifting device construction 1 is mounted on a chassis 2, in this case on a trailer, and can be transported with a tow bar 3 by means of a car. The trailer has its bogie assembly 4 lifted in this solution to a top position and the lifting device construction has its support legs 5 extended for stabilizing and leveling the lifting device construction 1. The support legs 5 are preferably for example hydraulically operated telescopic legs, which are movable in vertical and horizontal directions for setting the lifting device construction 1 in a substantially horizontal solid position. The lifting device construction 1 can also be built so as to comprise in itself a chassis 2, which is fitted with wheels for maneuvering the lifting device construction 1 independently for example by means of an electric motor.

The lifting device construction has its walking platform 6 and working platform 7 making up an integral assembly and that has been lifted up with a hoist mechanism 8, which in this example is a threaded telescopic assembly. The hoist mechanism 8 bears itself on a bottom surface of the working platform 7 or is connected by way of bracing members to vertical walls present between the working platform and the walking platform 6, whereby, when in its bottom position, the hoist, mechanism remains, as far as its main components are concerned, between the working platform and the walking platform. The invention is not limited solely to the exemplified hoist mechanism 8, but the hoist mechanism can be established by using any prior known technology, such as for example a scissor lift, a hydraulic cylinder, or the like. The walking platform 6, which extends around the working platform 7, is further surrounded along its outer edge by a rail 9 for preventing a fall.

FIG. 2 shows the lifting device construction 1 in an overhead view. The lifting device construction has its legs 5 spread and the lifting device construction 1 is displaceable in horizontal plane upon the telescopic legs as indicated by an arrow 10. Thus, the lifting device construction 1 can be brought for example into contact with a wall making up the worksite or to the immediate proximity of a wall. The lifting device construction 1 can have its working platform 7 fitted with working tools/machines 11, which in this embodiment is a circular table saw for cutting boards. Such boards can be placed on top of support members 12 present in a rear portion of the working platform 7 to wait for being cut to size. On the other side of the walking platform, 6, the cut to size boards can in turn be transferred onto the top of support structures 13 placed inside the rail 9 for an easy final installation from there. Such a support structure 13 is preferably mounted in a movable manner on the rail 9 and is displaceable in lateral direction to a worksite. In this embodiment, the walking platform 6 has been enlarged with two extensions 14 for increasing the operating range of the lifting device construction 1. If necessary, the working platform 7 can also be lengthened, for example for facilitating the handling of long pieces of sawn timber.

In the embodiment of FIG. 2, it is easy to load required building materials on top of the support members 12 while the lifting device construction 1 is in its bottom position. Thus, it is also easy for an employee to climb to the top of the lifting device construction 1 onto the walking platform 6 as the climbing height is reasonable. The hoist mechanism remains neatly in concealment below/inside the working platform and the side walls of a working platform structure.

Described above are just by way of example a few preferred embodiments of the invention. However, the examples are by no means restrictive regarding the scope of protection, but the invention has its scope of protection defined in accordance with the appended claims.

1. A lifting device construction comprising:
a walking platform,
a working platform connected to the walking platform with vertical members, and
a hoist mechanism for maneuvering an assembly made up by the working platform and the walking platform together,
so that when the lifting device construction is in its bottom position, the hoist mechanism, regarding its main components, is accommodated between the working platform and the walking platform.

2. The lifting device construction according to claim 1, wherein the hoist mechanism is a scissor lift, a threaded telescopic lift, or a hydraulic lift.

3. The lifting device construction according to claim 1, wherein the walking platform extends at least partially around the working platform, providing at least one working point next to the working platform.

4. The lifting device construction according to claim 1, wherein the walking platform has one or more detachable and attachable extensions protruding outward from the working platform.

5. The lifting device construction according to claim 1, wherein the working platform is provided with various working tools/machines.

6. The lifting device construction according to claim 1, wherein the lifting device construction has a rail fitted with a movable support structure.

7. The lifting device construction according to claim 1, wherein the working platform is enlarged with additional elements.

8. The lifting device construction according to claim 1, wherein the lifting device construction is maneuverable on top of its own wheels or the lifting device construction is mounted on top of a movable trailer.

9. The lifting device construction according to claim 1, wherein the lifting device construction is provided with support legs extending outwards from the lifting device construction for preventing the lifting device construction from toppling and for setting it in a substantially horizontal operating position.

10. The lifting device construction according to claim 9, wherein the lifting device construction is displaceable in a horizontal plane on top of a structure constituted by the support legs.

11. The lifting device construction according to claim 5, wherein the working tools/machines are selected from the group consisting of a circular table saw and a storage structure.
